(19) United States
(12) Patent Application Publication
(10) Pub. No.: US 2006/0015638 A1
(43) Pub. Date: Jan. 19, 2006

(54) Method and apparatus for initiating telephone call from a mobile device

(76) Inventors: Lisa D. Holzhauser, San Carlos, CA (US); Robert A. Lambourne, Menlo Park, CA (US); John C. Simmons, Bellevue, WA (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 11/209,966

(22) Filed: Aug. 22, 2005

Related U.S. Application Data
(63) Continuation of application No. 09/221,952, filed on Dec. 28, 1998.

(51) Int. Cl. G06F 15/16

(52) U.S. Cl. 709/232

(57) ABSTRACT

An information apparatus comprising information acquisition resources, distribution resources, association resources and control coordinating resources. The control coordinating resources coordinate the activations of the acquisition and association resources. The association resources provide an association annotation to the distribution resources, and the distribution resources distribute responsive thereto. The association annotation is based on at least one of the information acquired by the acquisition resources or directives provided in accordance with prevailing configuration of the apparatus. The apparatus also comprises one or more of: (a) processing resources, (b) administration resources, the administration resources (comprising at least one of timer facilities, prompting facilities, and configuration facilities), and (c) exploiting resources (to which the distribution resources distribute all or part of the information and the association annotation). The configuration facilities support (i) a shared relevance space, the shared relevance space supporting enhanced coordination between the acquisition and distribution resources and (ii) tracking of user's use of the apparatus.

### BACKGROUND

This invention relates to information and resource management associated with an information apparatus in a communication environment and, particularly, to such management by coordinated acquisition and distribution of the information.

A typical information apparatus is a computing device (e.g., a personal computer). In specifying, designing and implementing computing devices, ease of use typically is emphasized. This emphasis evidences a recognition that the easier a computing device is to use, the more likely that users (a) will feel compelled to invest in the device (e.g., by purchase or upgrade) and (b) once invested, will fully exploit the device's features (e.g., establish an accessible database of contacts and appointments), enjoy the benefits of the device (e.g., schedule and attend meetings without conflict and on time) and achieve their objectives (e.g., increase productivity) so as to be satisfied with their investment.

Toward enhancing ease of use, computing device's support speech recognition technology. Such technology includes hardware and software that recognizes a user's voice so as to enable the user to speak to the device for one or more of recording, command/control and/or speech-to-text transcription. These capabilities promise, among other things, increased productivity by decreasing/minimizing dependence on a keyboard, pointing device or other manipulable input facility to operate the computing device.

In order to realize its promise, speech recognition technology is being driven beyond mere recognition capabilities. For example, speech recognition technology is advancing to deliver enhanced context sensitivity. Context sensitivity enables a computing device to determine, and act in concert with, the meaning and intent of a users spoken words, which determination is accomplished from analysis not only of the words themselves, but also of, e.g., the tone, context or other expression attending the words.

Context sensitivity promises to liberate the user substantially, if not fully, in the operation of the computing device. As an example, context sensitivity has the potential to greatly enhance the user's efficiency and productivity in managing each of the users' information, the computing device's resources and other resources of any communication environment.

However, operational context sensitivity, via voice or otherwise, is not likely to be soon realized. As to such information and resource management, then, more immediate challenges prevail. One such challenge is to closely coordinate, on the one hand, the resources of the computing device that support acquisition of information and, on the other hand, other resources of, or available to, the computing device. In that regard, the device's acquisition resources support, e.g., speech recognition, text/graphic/photo/biometric scanning, audio recording, video recording and photography (i.e., image acquisition). Moreover, such other resources typically are enabled to receive, become associated with, operate on and otherwise exploit all or part of the acquired information.

The challenge of information and resource management is particularly applicable to computing devices having relatively small form factors. These devices typically are characterized by a powerful user desire to optimize information management, particularly in the context of the supported mobile operations. As an example, a personal digital assistant (“PDA”) is recognized as a desirable information management tool, particularly because it is highly transportable, limits operations to a relatively manageable number, and tends to focus on operations that generally are relevant to the PDA's function (e.g., keyed to transportability). Moreover, its desirability and overall value tends to increase with advances in its ability to acquire and exploit information vis a vis such relevant operations. Such exploitation typically is through resources associated (a) with the PDA itself and/or (b) with an associated communication environment, such environment comprising, as examples, one or more of (i) a host personal computer (“PC”), where communication is, e.g., via PDA-host PC synchronization, (ii) a non-host PC, where communication is, e.g., via peer-to-peer communication and (iii) a network (e.g., a LAN, a WAN, an Intranet, and/or an Internet). To illustrate, a PDA that includes audio recording resources tends to increase in desirability as decreases are achieved in the amount of user skill and effort consumed toward distributing any particular recording (or its content) to a particular resource, anywhere disposed. Meeting that challenge promises to yield advantages, including, as examples, increased ease of use and enhanced productivity.

Accordingly, a need exists to closely coordinate resources supporting acquisition of information with other resources of an information apparatus or its communication environment.

### SUMMARY

The present invention addresses the challenges inherent in the prior art, including the challenges of information and resource management, by coordinating the acquisition and distribution of information by an information apparatus in a communication environment.

According to one aspect of the invention, an information apparatus is provided that comprises information acquisition resources, distribution resources, association resources and control coordinating resources. The control coordinating resources coordinate the activations of the acquisition and association resources. The association resources provide an association annotation to the distribution resources, and the distribution resources distribute responsive thereto. The association annotation is based on at least one of the information acquired by the acquisition resources or directives provided in accordance with prevailing configuration of the apparatus. The apparatus also comprises one or more of: (a) processing resources, (b) administration resources (comprising at least one of timer facilities, prompting facilities, and configuration facilities), and (c) exploiting resources (to which the distribution resources distribute all or part of the information and the association annotation). The configuration facilities support (i) a shared relevance space and (ii) tracking of user's use of the apparatus. The shared relevance space supports enhanced coordination between the acquisition and distribution resources

The various features of novelty which characterize the invention are pointed out with particularity in the claims annexed to and forming a part of this specification. For a better understanding of the invention, its operating advantages and specific objects attained by its use, reference should be made to the accompanying drawings and descriptive matter in which its preferred embodiments are illustrated and described, wherein like reference numerals identify the same or similar elements.

### BRIEF DESCRIPTION OF THE DRAWINGS

The drawings include:

FIG. 1 showing a block diagram of a communication environment, such environment including plural information apparatus and supporting acquisition, association and distribution of information, according to the principles of the invention;

FIG. 2 showing a block diagram of an information apparatus enabled to acquire, associate and distribute information, according to the principles of the invention;

FIG. 3 showing an enabled information apparatus implemented as a computing device, in the form of a personal digital assistant, in accordance with the invention; and

FIG. 4 showing a block diagram of a personal digital assistant enabled to acquire, associate and distribute information, according to the principles of the invention.

### DETAILED DESCRIPTION

Introduction.

Information science, generally, involves the study of how information is collected, organized, handled and communicated. As such, information science tends to be tied to computing. Accordingly, computing and its evolution provides context to this invention.

In that regard, the computer industry's evolution is marked by reductions in price and form factor. In earlier days, the industry produced relatively expensive, room-sized main frame computers, which equipment was primarily directed to well-financed corporations and academia. Gaining maturity, the industry developed mini computers, in part to capitalize on market segments that demanded less expensive, smaller equipment. Maturing further, the industry developed personal computers (“PC”s) which equipment, because of its small size and affordable price, ushered in an era of computing not only on every desk in the office, but also in the home.

The computer industry developed various PC hardware platforms, including: 1) the so-called desktop PC that typically comprises a relatively cumbersome box for positioning, essentially permanently, on or beside a desk, and that typically is accompanied by and/or used with peripheral devices for input/output of data, these devices including a monitor, a keyboard, one or more pointing devices (e.g., a mouse), a printer, and communication facilities; 2) the so-called notebook (or laptop) PC that typically comprises a relatively lightweight, readily transportable box sized roughly proportional to common notebooks, the box conventionally designed to open like a clamshell to expose, on one interior side, a screen (e.g., liquid crystal) and, on the other interior side, a keyboard; and 3) the personal digital assistant (“PDA”) that typically is highly compact and lightweight (e.g., sized roughly proportional to and weighing about as much as a common wallet or billfold), so as to accommodate both transport on one's person (e.g., in a jacket pocket) and ready operation in and from the user's hand.

PDAs conventionally have two forms: (a) the handheld PC (“HPC”) which generally is a scaled-down clamshell box with an LCD screen and an integrated, miniature keyboard and (b) the palm-sized PC (“PPC”) which generally is tablet-like, typically having a touch-sensitive screen, while omitting an integrated, hard keyboard (various so-called soft keyboards may be supported via the touch-sensitive screen). The Poqet PC Classic, from the Poqet Computer Corporation, Santa Clara, Calif., is an example of the HPC. The Classic, first shipped in March 1990, has dimensions of 8.8″×4.3″×1″ (22.3 cm×10.9 cm×2.5 cm) and weighs 1.2 lb (0.54 kg) w/batteries. The MessagePad with the Newton operating system, from Apple Computer, Inc., Cupertino, Calif., is an example of a PPC. The original MessagePad, introduced in 1993, has dimensions and weight similar to those of Poqet's Classic. More recent PPCs have dimensions approximately one third of the original MessagePad, weigh about a half pound, and typically operate using either the WindowsCE operating system of Microsoft Corporation, Redmond, Wash. or the Palm operating system of 3Com Corporation, Santa Clara, Calif.

Additional PC platforms include convergence devices which integrate PC-features with conventionally non-PC features. As an example, the 9110 Communicator, from Nokia Mobile Phones, Espoo, Finland, is a smart phone; it combines a cellular telephone and a HPC, so as to support (i) sending/receiving phone calls and fax, (ii) Internet access, such as for e-mail and web browsing, and (iii) computing applications, such as calendaring, note-taking and other information management. As another example, Microsoft has announced the AutoPC, a WindowsCE-based system, purportedly for supporting vehicular navigation, information retrieval (e.g., local history and points of interest), status, communication and entertainment.

PC hardware platforms comprise general purpose computers and, therefore, tend to be versatile. That is, each platform typically supports a wide variety of acquisition resources, such resources being directed to a plurality of information types (e.g, audio, video, images, graphics, text and data). Moreover, each such platform tends to support distribution of acquired information to a plurality of other resources which, typically, are enabled to receive, operate on, exploit and otherwise become associated with all or part of the acquired information (hereinafter, these resources are generally referred to as “exploiting resources”).

Each of the number and variety of acquisition and exploiting resources tends to vary among the various PC platforms. In part, this responds to the circumstance that each platform is a compromise among desirable characteristics and features. Accordingly, while some platforms excel over other platforms for one purpose, the latter platforms tend to excel over the former platforms for another purpose. To illustrate, while a fully-configured, state-of-the-art desktop PC tends to support speedier computing, greater storage capability, more and more-fully-featured applications and superior input/output of data than each of the HPC and the PPC, these HPC/PPCs tend to be less expensive and to feature applications that optimize information management/communication—particularly personal information management—specifically in the context of the supported mobile operations.

Although a typical information apparatus is a computing device based on a PC hardware platform, information apparatus can be otherwise, without departing from the principles of the invention. As an example, an information apparatus can include a cellular phone. A typical cellular phone now enables acquisition of voice and keyed information (via microphone and keypad entries), while also enabling the user to direct any particular acquired information to various exploiting resources (e.g., a voice messaging resource of the user, other voice messaging resources, fax resources, email resources, banking resources, paging resources, and the like).

Regardless of information apparatus, improvements can be made. In that regard, this invention is directed to information apparatus—particularly PC platforms—respecting management of information, of the platform's resources, and of resources otherwise available in or via a communication environment. More specifically, this invention is directed toward improvements providing enhanced coordination between, on the one hand, an apparatus' resources that support acquisition of information and, on the other hand, exploiting resources of, or available to, the apparatus.

The improvements in information and resource management are particularly applicable to information apparatus having relatively small form factors. These devices typically are characterized by a powerful user desire to optimize such management, particularly in the context of mobile operations. As an example, a PDA is recognized as a desirable information management tool. Moreover, its desirability and overall value tends to increase with advances in its ability to acquire and exploit information in operations associated with its transportability. Such exploitation typically is through exploiting resources of, or associated with (a) the PDA itself and/or (b) a communication environment, such environment comprising, as examples, one or more of (i) a host PC, where communication is, e.g., via PDA-host PC synchronization, (ii) a non-host PC, where communication is, e.g., via peer-to-peer communication and (iii) a network (e.g., a LAN, a WAN, an Intranet, and/or an Internet).

The improvements in information and resource management are also particularly applicable to information apparatus having certain resources that can be identified to a shared relevance space. Such resources may be so identified from among a larger universe of supported resources, presumably directed to a variety operations. As an example, PDAs tend to focus on operations that are deemed relevant to transportability. Resources consistent with such operations tend to be identified to the PDA's shared relevance space. At the same time, PDAs can, and generally do, support operations that are not so identified.

The present invention provides for enhancing coordination between acquisition and exploiting resources by bridging such resources via information association resources. The information association resources, as described in greater detail below, coordinate with the acquisition resources so as to reduce and/or minimize, and preferably optimally so, the amount of user skill and effort consumed toward distributing any particular information to any particular exploiting resources. This is particularly applicable to resources of a shared relevance space.

Employing such association resources yields advantages. These advantages includes, as examples, enhanced management of information and resources, increased ease of use and enhanced productivity vis a vis the implicated information apparatus. To illustrate, an information apparatus -such as a PDA—that includes audio recording resources tends to increase in desirability as decreases are achieved in the amount of user skill and effort likely to be consumed toward distributing any particular recording to any particular resources, anywhere disposed.

Terminoloqy.

The term “information” refers to signals, commands, instructions, data and other information, with or without interpretation or meaning.

The term “information type” refers to control, voice (phonemes or otherwise), audio, video, camera images, graphics, text, handwriting, data or other type of information, alone or in combination, regardless of the format.

The term “facilities”, as used in this specification, refers to hardware (including firmware) component(s), software component(s), and network component(s), alone or in combination(s) of one or more of these components.

The term “resources”, as used in this specification, refers to one or more facilities, and/or to the component(s) comprised therein.

The term “exploiting resources”, as used herein, refers to resources which, typically, are enabled to become associated with, are associated with, or were associated with all or part of the information acquired by information acquisition resources. Such term, unless the context indicates otherwise, also refers to resources sometimes referred to herein as “exploited resources”, which exploited resources become associated with information through intermediate exploiting resources. Typical exploiting resources support, as examples, email, voicemail, fax, task (“to do”) listing, calendaring, scheduling, contact management, dialing, browsing, note-taking and other information management.

The terms “association”, “associated” and variants thereof, as used in this specification with reference to “information” and “resources”, contemplate any purpose, including, as examples, acquiring, receiving, defining, evaluating, safeguarding, processing, presenting, addressing, distributing or being distributed by, exploiting or being exploited in connection with, or otherwise supporting, operating on/with, or being operated on in connection with information, including one or more information types.

The term “information apparatus”, as used herein, contemplates any device, equipment, system or other apparatus having resources relevant to, or capable of supporting, the invention described herein. As such, the term, in accordance with the invention, is intended to have, and has, a wide breadth, contemplating, without exhaustion, (a) TVs, VCRs, receivers, audio CD players and other audio and video equipment, (b) ventilation, air conditioning and heating systems, and associated thermostats, control panels and the like, (c) lighting systems, (d) security, safety, and positioning systems, (e) home appliances and tools, (f) health care instruments and equipment, (g) telephone, transcription, copy, fax and other office equipment, (h) machine tools, assembly, handling, moving and other production equipment, (i) computing device, including such devices based on conventional PC platforms, and 0) other home, business, automobile and entertainment products and systems. If implemented as a computing device, an information apparatus typically comprises one or more of: a display and/or other output facilities; input facilities; communication facilities; memory facilities; and processor facilities. Among such facilities, the information apparatus generally includes selected software components, such as an operating system (including utilities) and application programs.

The term “enabled information apparatus”, as used herein, contemplates any information apparatus that is configured to, and does, support the invention described herein.

The term “communication environment”, as used herein, refers to the aggregate of resources associated with, or capable of becoming associated with, information acquired by an enabled information apparatus, such aggregate including any apparatus, system or network incorporating any aggregated resource. Such aggregated resources, generally, are provided (a) as part of one or more information apparatus, (b) as part of one or more communication networks, such as the Internet, or an Internet-like system, or the World Wide Web, or a World-Wide-Web-like system, or a LAN, or a WAN or any other network or service thereof, and/or (c) in other appropriate manner. As an example, a communication environment may comprise one or more of (i) a PDA comprising an enabled information apparatus, (ii) a host PC supporting, e.g., synchronization with the PDA, (iii) a non-host PC, supporting, e.g., peer-to-peer communication with the PDA and (iv) a network (e.g., an Intranet, and/or an Internet) supporting communication among the PDA and other information apparatus. As to the PDA of this example, the communication environment comprises not only the PDA, but also other resources that may be, and typically are, exploiting resources.

Communication Environment.

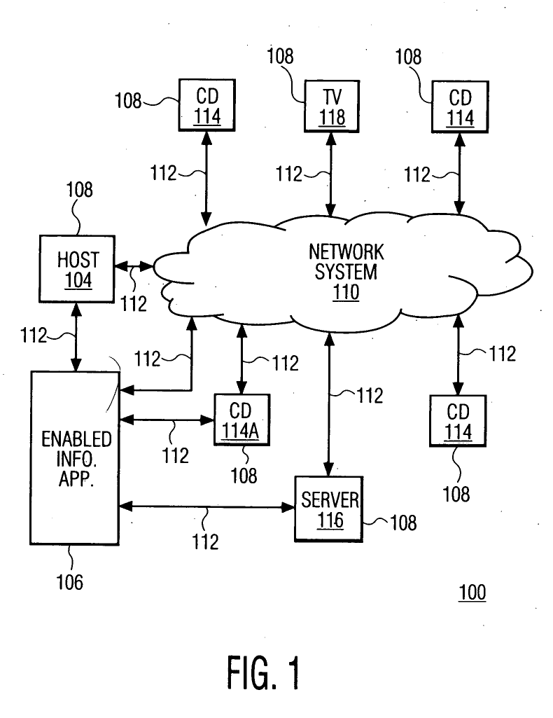

FIG. 1 shows an example communication environment 100 associated with an enabled information apparatus 106 and having plural other information apparatus 108. The apparatus 108 comprise a host 104, a server 116, plural computing devices 114 and a consumer electronic (CE) device 118 (e.g., a television). As shown, the enabled information apparatus 106 is coupled directly to each of the host 104, the server 116 and the computing device 114A, while also being coupled indirectly—via a network system 110—to the other computing devices 114 and to the CE device 118. In that regard, the network system 110 generally provides for coupling each information apparatus 108 to each of the other information apparatus 108.

The host 104 typically is a computing device with which the enabled information apparatus 106 co-operates. Generally, the host 104 supports synchronization with the enabled information apparatus 106. Synchronization contemplates handshaking and other predetermined processes by which information is exchanged between the host 104 and the enabled information apparatus 106 so as to realize coherency therebetween, among selected software applications and/or other resources. As an example, in PDAs it is known to synchronize contact information, calendar entries, tasks, notes, electronic mail (“e-mail”) with and without attachments, and scheduling. Because synchronization is well known, it is not described further herein.

The server 116 runs selected software that administers a specified service (e.g., airline reservations, other ticketing, on-line voice recognitions and transcription). Via communication channels 112 and network system 110, the server 116 receives from and transmits to clients (e.g., one or more information apparatus 108 and/or the enabled information apparatus 106) information concerning the features and functions supported by the service. Generally, to do so, the server runs server software and the client runs client software. Because the operation of client-server arrangements is well known, it is not described further herein.

The network system 110 comprises any selected network or group of networks. As such, the network system 110 comprises, as examples, a LAN, a WAN, an Intranet, an Extranet, an Internet, other networks, and/or combinations of one or more of these networks. As to an Internet, the network system 110 includes the services supported thereby, such as the World Wide Web, other hypertext-based systems, facsimile transmissions, telephony, email, file transfer, file storage, and others. The network system 110 comprises networks of any and all topologies.

The communication channels 112 comprise any communication link. Between the enabled information apparatus 106 and the host 104, an example communication channel 112 comprises a docking connection. As an example, in PDAs, the docking connection is generally referred to as a cradle, where insertion of the PDA in the cradle typically initiates synchronization between the apparatus 106 and the host 104. Between the enabled information apparatus 106 and the network system 110 or other information apparatus 108 (including the server 116), example communication channels 112 comprise modem-based connections (via switched telephone lines, cable utilities, or wireless facilities), near-field radio connections, infrared-based connections, and network wires. Such example communication channels 112 can also apply between the information apparatus 106 and its host 104.

Although an embodiment of a communication environment 100 is shown in FIG. 1, it is to be recognized that the communication environment 100 can be otherwise implemented without departing from the principles of the invention. In that regard, FIG. 1 shows a communication environment 100 that attempts to describe connections between information apparatus 106, so as to embrace the widest range of options for information association. In any particular implementation, the communication environment 100 may provide all, selected, plural, combinations or other connections.

In any case, it is to be understood that the communication environment 100 typically comprises information apparatus 108, wherein at least one such apparatus comprises information acquisition resources and at least one such apparatus comprises exploiting resources. Moreover, the communication environment 108 also comprises association resources by which acquisition and exploiting resources are bridged. The information association resources coordinate with the acquisition resources toward enhancing distribution of any particular information to any particular exploiting resources. An information apparatus 108 comprising acquisition resources preferably also comprises the association resources. However, it is recognized that the association resources may be otherwise disposed—e.g., in a remote device or otherwise in the communication environment 100, without departing from the principles of the invention.

It is to be recognized that, one information apparatus 108 can comprise both information acquisition resources and exploiting resources. To illustrate, the enabled information apparatus 106, as a PDA, may implement exploiting resources, such resources providing for, in turn, contact management, calendaring, task (“to do”) listing, note taking, electronic mail (with and without attachments), and scheduling.

Moreover, through the resources of the environment 100, the information acquired by the enabled information apparatus 106 is, is enabled to become or becomes distributed to exploiting/exploited resources of one or more other information apparatus 108. As an example, a communication environment 100 may comprise: (i) an enabled information apparatus 106 implemented as a PDA, the PDA comprising both information acquisition resources and information association resources; (ii) a host 104 implemented as a desktop PC, the PC having exploiting/exploited resources that comprise application software, and the PC supporting synchronization with the PDA, so that, upon synchronization, associated information becomes distributed to the exploiting resources; and (iii) other information apparatus 108 implemented as various PC platforms and CE devices, each such platform and device having exploiting/exploited resources, and the platforms/devices supporting peer-to-peer communication with the PDA, such communication providing for associated information to become distributed to the respective exploiting resources. In this example, the exploiting/exploited resources of each such information apparatus can be variously comprised; such resources including, as examples, voice recognition resources (e.g, that operate based on phoneme information), publishing resources (e.g., that operate based on various information types), group scheduling resources, airline ticketing resources, and display, print, loudspeaker and other output resources.

Information Apparatus.

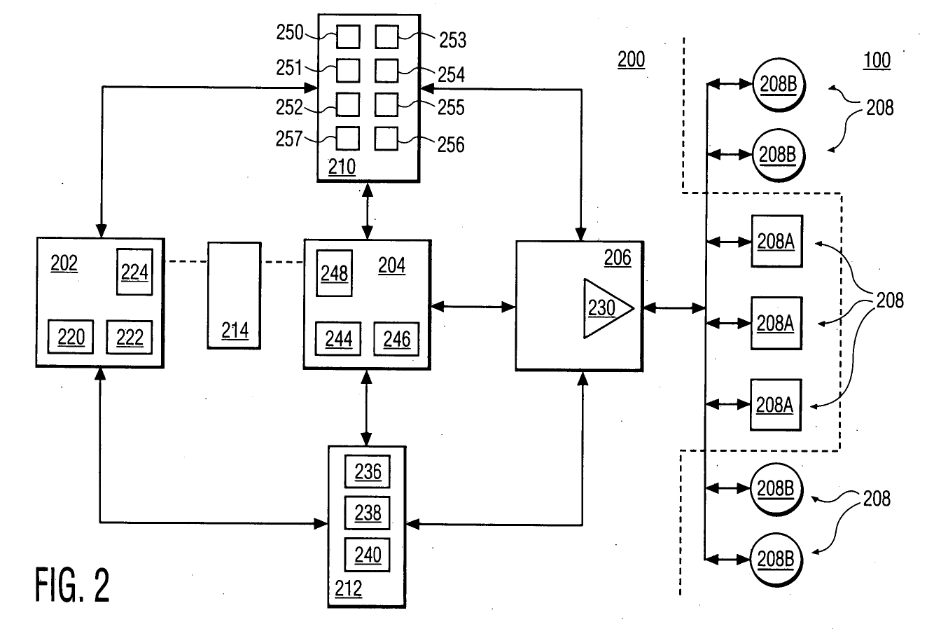

An enabled information apparatus 200, according to the present invention, is shown in block diagram form in FIG. 2. The enabled information apparatus 200 preferably comprises information acquisition resources 202, association resources 204 coupled to the acquisition resources 202, distribution resources 206 coupled to the association resources 204, and exploiting resources 208 coupled to the distribution resources 206. The enabled information apparatus 200 also preferably comprises processing resources 210 and administration resources 212, both of which being coupled to each of the acquisition, association and distribution resources 202, 204, 206. The enabled information apparatus 200 also preferably comprises control coordinating resources 214 coupled to the acquisition resources 202 and to the association resources 204.

While the enabled information apparatus 200 preferably comprises each of the above resources 202-214, it is to be recognized that FIG. 2 is not intended to depict the physical architecture of the apparatus 200. Rather, it is intended to illustrate resources, as well as the communication and control among the resources. While, in any particular implementation, FIG. 2 may reflect the actual physical architecture, it is to be recognized that the architecture of the apparatus 200 may be other then as illustrated, without departing from the principles of the invention. To illustrate, the association resources 204 may be disposed external to the apparatus 200, such as in a remote device or otherwise in the communication environment 100, without departing from the principles of the invention.

The acquisition resources 202 provide for acquisition of information. The acquisition resources 202 preferably are enabled to provide information representative of and/or responsive to the user's interaction with and in a physical environment. In doing so, the acquisition resources 202 preferably support acquisition both of the information subject to association (sometimes referred to in this Specification as “associated information”), as well as the commands and other control information contributing to the association, either as precursors thereto or as the actual associations (the commands and other control information are sometimes referred to herein as “directives”).

The acquisition resources 202 preferably support acquisition of various, selected information types (e.g, control, audio, video, images, graphics, text, handwriting and data—such as biometric or ambient environmental data). As such, the acquisition resources 202 preferably comprise transducing facilities 220. The transducing facilities 220 include, for example, one or more of a touch-sensitive screen, a hard or soft keyboard, a pointing device (e.g., a mouse, trackball, touch pad, and/or a joystick), a microphone, a still image or video camera, optical scanners, ambient condition detectors (e.g., thermometers, barometers, chem/bio-sensitive reaction chambers or chips), biometric detectors, and other transducing facilities, alone or in combination.

Accordingly, transducing facilities 220 are selectively employed in relation to one or more types of information for acquisition. Examples of transducing facilities and related information types include: a microphone—employed to acquire audio, such as voice/phonemes; a digital camera (including a lens and a charge-coupled device, or equivalent)—employed to acquire images and video; a touch-sensitive screen—employed to acquire handwriting, text and graphics; an optical scanning device—employed to acquire graphics, bar codes, text, biometric data or the like; and ambient condition detectors—used to acquire ambient conditions data (e.g., temperature readings).

The acquisition resources 202 typically also comprise various coupling facilities 222. Coupling facilities 222 preferably provide for acquiring selected information with/from other information apparatus or otherwise types (e.g.,via, in a computing device, serial, parallel, USB, cradle and/or other ports). Coupling facilities 222 preferably support any and all communication formats, protocols and specifications, whether presently used or not, as well as their equivalents and/or combinations thereof. Supported formats, protocols and specifications include, without limitation: infrared standards (e.g., IrDA D and C, and AIR); radio frequency standards (e.g., the proposed Bluetooth and Home RF specifications); Internet standards and services (e.g., TCP/IP, HTTP, SMTP); other connectivity standards (e.g., USB, Firewire, and conventional serial, parallel and A/V ports); as well as proposed home networking specifications (e.g. HAVI and HAPI).

While the acquisition resources 202 preferably support acquisition both of the associated information and the directives, it is to be recognized that each may or may not be acquired via the same coupling or transducing facilities 222, 220. As an example, the information subject to association may be voice type and acquired via a microphone. In one case, the directives may also be voice type, and acquired via microphone. However, in another case, the directives may be handwriting type, acquired via a scanner or a touch-sensitive screen. In yet other cases, the directives may be control type acquired via coupling facilities 222 (e.g., from the communication 5 environment 100) or from the apparatus' memory (e.g., pre-set preferences). In still other cases directives may be omitted entirely (e.g., the type of information acquired and the state of the enabled information apparatus 200 describe a default circumstance where association(s) is made.

The acquisition resources 202 also typically comprise acquisition control facilities 224. Such facilities 224 can be variously implemented. In any case, however, such facilities 224 provide for activating selected transducing or coupling facilities 220,222, such activation generally being triggered through user manipulation or other actuation of the facilities. As an example, in a PDA, a transducing facility 220 typically is a touch-sensitive screen, which screen generally remains activated. In addition, however, the PDA may comprise one or more other transducers, for which typically are provided acquisition control facilities 224. Such PDA control facilities 224 typically include, as examples, a button (e.g., to activate a camera or microphone), a contact detector (e.g., to activate a hand-held optical scanner), or an audio signal strength detector (e.g., to activate an audio recorder).

In a typical embodiment, separate acquisition control facilities 224 are provided for each transducing or coupling facilities 220,222. However, it is to be recognized that selected transducing and coupling facilities 220, 222 may be grouped together for activation through actuation of one acquisition control facilities 224. In such case, the particular transducing and coupling facilities 200,222 that ultimately are activated may be variously determined: in one case, the most recently active of such facilities 220,222 is activated, while in another case, recently-added facilities may be activated and, in a third case, it is determined by context, typically in view of configurations (e.g., of a shared relevancy space). In any case, the prompting facilities 238 preferably are configured to send a confirmation prompt (e.g., timer components are triggered such that time-outs will occur if the user fails to respond within the time-out periods).

The acquisition resources 202 typically operate in coordination with other of the resources, such as processing resources 210. In that regard, the processing resources 210 preferably are enabled to operate upon or in relation to acquisition of information. Even so, the processing resources 210 preferably also operate in coordination with other resources, including the association resources 204, distribution resources 206 and the exploiting resources 208.

The processing resources 210 preferably comprise a variety of facilities for selectively processing information. In that regard, the facilities of the processing resources 210 typically comprise one or more of, as examples: conditioning facilities 250 (e.g., particularly for filtering, sampling and the like respecting acquired, analog signals); analog-to-digital conversion (“ADC”) facilities 251; buffering or other storage facilities 252; recognition facilities 253 (e.g., for translating graphics-to-text, audio-to-phonemes, audio-to-text, handwriting-to-text, handwriting-to-phonemes, gesture-to-meaning, etc.); encryption facilities 254 (for encrypting and decrypting information); compression facilities 255 (for compressing or decompressing information); coding facilities 256 (for decoding and encoding information); and composing facilities 257 (for packaging information into or unpackaging information from a format). To illustrate, if the acquisition resources 202 acquire an analog audio stream that corresponds to speech, the processing resources 210 may be tasked with converting the stream to digital and, therefrom, translating the digital information to generate either phonemes or text. Similarly, if the acquisition resources 202 acquire an image, the processing resources 210 ultimately may be tasked with converting the image data into JPEG format.

Moreover, processing resources 210 may be variously implemented. As described above, the processing resources 210 may include facilities which, in some implementations, may be, or be comprised by, exploiting resources 208. Furthermore, in some implementations, certain facilities may be comprised by both processing and exploiting resources 210, 208, as well as other resources. As an example, voice recognition software applications running on a computing device provide, in conjunction with other facilities of the device, for translation of acquired speech to text. In a circumstance where the translation is the purpose of the acquisition (e.g., dictation for work processing), the software application typically is comprised by exploiting resources 208. However, in a circumstance where translation is an intermediate step, e.g., in preparing a proposed itinerary in ordering airline tickets, the software application typically is comprised by processing resources 210, and the exploiting resources 208 comprise a server 116 that receives the test in completing the ticketing transaction. In this latter circumstance, the recognition software also may be comprised as exploited resources 208 in the event that associated information is directed to the server 116 and, thereafter, is redirected to the software for translation of the information for return to the server 116. (See the discussion above respecting processing resources 210 operating in coordination with other resources, including exploiting resources 208).

The processing resources 210 are shown as aggregated in a single, separate block. However, it is to be recognized that the processing resources 210 may be implemented in any other appropriate manner, including by implementing one or more facilities of the resources 210 as part of one or more other resources 202, 204, 206, 208, 212 and 214. It is to be recognized that the facilities of the processing resources 210 are provided to support processing of information and, as such, can be implemented (or not) as determined to be desirable, case by case, and as agrees with applicable factors, including, as examples, the information to be acquired, the capabilities of the acquisition resources 202, the features of the association resources 204, the limitations of the exploiting resources 208, and the features of any other implicated resources.

The distribution resources 206 preferably comprise a variety of facilities for selectively distributing information to exploiting resources 208. The distribution resources 206 so selectively distribute responsive to the association resources 204, which resources 204 preferably provide an association annotation, e.g., based on directives applicable to the information. The distribution resources 206, subject to any particular implementation, may also respond to other resources, including the processing resources 210 (e.g., using recognized information to determine all parameters of the directives) and the administrative resources 212 (e.g., to cause staging of the information in the event of a time-out, as described below).

The distribution resources' facilities typically are implemented in light of the characteristics of the exploiting resources 208. In particular, the facilities of the distribution resources 206 preferably are implemented based at least in part on the relationship of each exploiting resource 208 with/to both the enabled information apparatus 200 and the applicable communication environment 100. To illustrate as to exploiting resources disposed internal to the apparatus 200 (“internal exploiting resources”), the distribution resources' facilities preferably provide for internal distribution of information among the apparatus' acquisition and internal exploiting resources 202, 208A (e.g., such provision being by communication links internal to the apparatus). To illustrate as to exploiting resources disposed external to the enabled information apparatus (“external exploiting resources”), the distribution resources' facilities preferably provide for distribution of information among such external exploiting resources 208B via, e.g., communication links 112 and/or the network system 110 of the communication environment 100.

As previously stated, the environment's communication channels 112 can comprise various facilities. The facilities, in one case, support synchronization (e.g., between a transportable information apparatus—such as a PDA—and a host 104), whereby information becomes available to exploiting resources 208 of the host 104, and therefrom to other such resources 208. The facilities, in another case, support conventional communication links (e.g., in a computing device, serial, parallel, USB, and/or other ports) such as with other information apparatus, whereby information becomes available to exploiting resources 208 of such apparatus, and therefrom to other such resources 208. The facilities, in yet another case, support networking (e.g., via appropriate physical connections and protocols, such as Ethernet), whereby information becomes available to exploiting resources 208 available through the network, including, as an example, any such resources 208 of the network itself.

The distribution resources 206 preferably also comprise staging facilities 230. The staging facilities 230 support indirect distribution of information to exploiting resources. In so doing, the staging facilities 230 also preferably support delay in effecting distribution. As an example, an enabled information apparatus 200 in the form of a PDA acquires information through handwriting recognition, the information comprising a database entry. The database entry is intended for distribution to a host 104, which host supports a database program that engenders an exploiting resource 208. Until synchronization/link among the PDA and host 104, the entry is controlled by the staging facilities 230 of the distribution resources 206. If the PDA does not support the database, the entry preferably is stored in a staging area (i.e., in memory) together with the association annotation, and status data. If the PDA does support the database, an alternative is to distribute the entry to the internal database (e.g., as an exploiting resource 208), while storing the association annotation, as well as status data and an appropriate pointer to the database entry. As such, upon synchronization/link, the distribution resources 206 identifies the staged, undistributed information so as to effect distribution of the entry information to the host's exploiting resources 208 in accordance with the association directives.

The administration resources 212 typically comprise a variety of facilities supporting the functions and operations otherwise provided by the enabled information apparatus 200. Preferably, the administration resources' facilities support the functions and operations provided by one or more of the other resources 202-210, 214. In that regard, the administration resources' facilities generally comprise one or more of, as examples: timer facilities 236, prompting facilities 238, and configuration facilities 240.

The administration resources 212 are shown as aggregated in a single, separate block. However, it is to be recognized that the administration resources 212 may be implemented in any other appropriate manner, including by implementing one or more facilities of the resources 212 as part of one or more other resources 202, 204, 206, 208, 210 and 214. It is to be recognized that the facilities of the administration resources 212 are provided to support administrative tasks respecting the information-related operations and functions and, as such, can be implemented (or not) as determined to be desirable, case by case, and as agrees with applicable factors, including, as examples, the information to be acquired, the capabilities of the acquisition resources 202, the features of the association resources 204, the limitations of the exploiting resources 208, and the features of any other implicated resources.

The administration resources' timer facilities 236 preferably comprise both timer components and monitoring components. In a typical embodiment, a timer component keeps track of the time elapsed following the occurrence of one or more selected first classes of timer events and until the occurrence of one or more selected second classes of timer events. In turn, a monitoring component monitors an associated timer component's tracking of elapsed time. As an example, a monitoring component can be implemented to monitor an associated timer for elapsed time exceeding a predetermined maximum period (the period being sometimes referred to as a “time-out period” and the timer event being sometimes referred to as a “time-out”). Moreover, responsive to a time-out, the monitoring component preferably effects a time-out message, which message preferably has content and parameters that reflect the circumstances. In this and other embodiments, the time-out message preferably comprises sufficient information and direction so as to enable appropriate action (e.g., corrective action by the user).

The time-out message preferably is directed to the prompting facilities 238, in response to which the prompting facilities 238 generate appropriate prompts or other output directed to, and for, the user (e.g., via a display screen, audio announcements or otherwise). In this manner, any particular time-out is made known to the user.

The timer and monitoring components can be triggered using one or more approaches, depending on the implementation. In an example embodiment, a timer component is activated by the user's activation of either acquisition or association resources. As an example, if the user activates the acquisition resources to acquire dictation, a timer component is triggered. In such case, a time-out may occur if dictation is not acquired (e.g., user forgets or did not intend to dictate). With the time-out, a time-out message preferably is output, including, e.g., notice of the time-out and selected options (“tap to continue/start dictating”), which options preferably are few, while themselves being subject to time-outs if not activated within one or more relevant time-out periods.

On the other hand, if dictation is successfully acquired in this example, another timer component may be triggered respecting association of the information. In one case, the timer component is triggered based on user activation of association resources. Again, a time-out will occur and appropriate messages will be output if no association information is acquired. In another case, the association and/or prompting resources are automatically activated (e.g., due to recognition of the information type), so as to prompt for predetermined associations. Here, timer components are triggered such that time-outs will occur if the user fails to respond (e.g., with association selections) within the time-out periods.

The administration resources' prompting facilities 238 provide to the user various warnings, selections, confirmations and other announcements of events and/or directives. As an example, the prompting facilities 238 typically support auditory and/or visual warnings in the event of a time out, provided some user action is expected, as described above. As another example, the prompting facilities 238 preferably provide for confirmation of a user's association directives in the event that the directives are processed using recognition facilities (e.g, audio-to-text). In such case, the confirmation may also be subject to a timer; however, in such case, the recognition results are deemed correct (and accepted) in the event the user is inactive (i.e., declines to reject the recognition results) within the time-out period. As yet another example, the prompting facilities 238 preferably provide for presentation of all, or selected groups, of operations and functions supported by the enabled information apparatus 200.

The prompting facilities 238 typically support announcements respecting directives associated with one or more of the acquisition, association, processing, administration, distribution, control coordinating and/or exploiting resources 202-214. To illustrate, the prompting facilities 238 typically support visual presentation of selected objects, such objects (e.g., legended boxes for selection via tapping a touch-sensitive screen) corresponding directly or indirectly to association directives, or parts thereof. In that presentation, the prompting facilities 238 preferably are responsive to the state of the enabled information apparatus 200, so as to display objects which are likely to have greatest utility to the user (e.g., respecting management of the acquired information and of the apparatus' resources). Such utility preferably is determined, at least in part, based on configuration of the resources 202-214 (e.g., respecting configuration facilities 240 and any resources identified to an applicable relevance space). The prompting facilities 238, so responsive to state, typically enable the user, among other things, to quickly, easily, pleasurably, efficiently and otherwise optimally select desired and appropriate objects and, thereby, provide for minimal, reduced or optimally reduced user skill and effort consumed in regard to associated information.

The prompting facilities 238 preferably operate in conjunction with a user interface (e.g., a graphic user interface). In that regard, the prompting facilities 238 preferably provide an appropriate user interface or support such an interface as otherwise provided by the enabled information apparatus 200 (e.g., via the capabilities of an operating system, such as in a computing device). Moreover, the prompting facilities 238 typically support various features, including, as examples, the sequencing, layering, and other organizing of objects.

The administration resources' configuration facilities 240 enable the configuration of the is enabled information apparatus, including the resources 202-214. To do so, the configuration facilities 240 preferably provide for training of the enabled information apparatus 200 via training facilities. Such training facilities typically support the association resources 204, particularly the use of the administration resources' recognition facilities in connection with the association resources 204. As an example, the training facilities enable the use of voice and handwriting recognition in acquiring and effecting a user's association directives. Voice and handwriting training being understood in the art, such training facilities (and training methods) are not further described with respect to this FIG. 2.

The administration resources' configuration facilities 240 preferably also provide support for shared relevance spaces. The shared relevance space typically coordinates with the resources 202-214 to enhance association between selected acquisition resources 202 and one or more of the processing, distribution and exploiting resources 206-210, including selected operations and functions thereof. By doing so, the shared relevance space provides that certain information types, once acquired, are readily associated (e.g., via the association resources 204 and/or control coordinating resources 214) with one or more exploiting, processing and/or distribution resources.

The shared relevance space typically is implemented with respect to a selected few information types and, as to each such type, a selected few associated resources, operations and functions. Each of the information types and the resources, operations and functions typically is identified to the shared relevance space from among a larger universe of resources, operations and functions, as supported by an enabled information apparatus 200. In that regard, resources, operations and functions identified to the shared relevance space preferably are significantly limited in number, the number being selected so as to optimize ease of use, efficiency and the like, at least in a predetermined configuration (e.g., in advance of user specified configuration). The resources, operations and functions identified to the shared relevance space also tend to have logical, operational or other relationship.

In a broad sense, then, the shared relevance space engenders establishing, in one enabled information apparatus 200, a user interaction metaphor to emulate (and extend) each of a plurality of well-understood, easily-operated, single-function devices. The association of each of a select few information types (and/or its acquisition resources 202) with one or more of a specific, select few operations/functions of one or more exploiting resources 208, the number of such associations tends to remain small, with each such association emulating a single function device. Assuming that each such emulating association is readily accessible to the user and that each such emulated single function device has function that is readily understood by the user, the shared relevance space contributes to the enabled information apparatus' ease of use, efficiency and the like.

To illustrate, compare a PDA's polyfunctionality to the monofunctionality of a dictation machine and a camera. Each of the dictation machine and camera conventionally supports a single information type (audio and image, respectively), a single, recognized acquisition mechanism (a microphone and a lens/shutter, respectively), a single, recognized destination (tape and film, respectively), and an easily operated control mechanism (e.g., actuators and/or push buttons), by which the information is acquired and, without association, reaches its destination.

A PDA, on the other hand, tends to support a variety each of information types, acquisition resources, and exploiting resources (each of which may support plural exploited resources), while providing a plurality of hard buttons, soft buttons and other user control options (e.g., voice, text/graphics and handwriting recognition), by which information is acquired and, via the association resources, associated with one or more exploiting resources. Even so, a PDA tends to focus on selected acquisition and exploiting resources (as well as their operations and functions), such resources typically being deemed relevant to the PDA's transportability.

As such, a PDA's relevance space may be defined around transportability. Such relevance space may have identified thereto various example operations/functions, including one or more of calendaring, dialing, e-mail (with and without attachments), contact management, and resource management (e.g., opening documents and launching applications without use of a keyboard) to the space. In addition to the selected operations/functions, the relevance space has identified thereto selected information types, e.g., voiced audio information and photo image information. As such, the PDA emulates single-function devices through configuring associations between each of the selected information types (and/or acquisition resources) and identified operations/functions. Preferably, the PDA's overall number of so-configured, emulating associations remains manageably small, i.e., so as to optimize ease of use, efficiency and the like when the associations are effected via association resources 204.

It is to be recognized, that a PDA's so-configured, emulating associations may or may not implicate a corresponding conventional device. Here, however, in completing the illustration, the PDA can emulate both of the convention devices: the dictation machine and the camera. To do so, the PDA associates its microphone and camera (e.g., a digital camera among the transducing facilities 220) with exploiting resources 208 that provide for storage of, respectively, voiced audio information and photo image information. Moreover, the PDA typically is implemented so as to consume minimal user interaction in order to acquire audio and photo files and to direct such files. Indeed, the files preferably are obtained by user manipulation of an actuator (e.g., a button) that, when primarily manipulated (e.g., depressed), activates acquisition of associated information and, when secondarily manipulated (e.g, further depressed, held or released), activates acquisition (e.g., via voice) of directives and association responsive thereto.

In this illustration, it is to be understood that the directives' acquisition may precede in time the acquisition of information for association. Moreover, it is to be recognized that the directives' acquisition may be implemented absent any secondary manipulation of an actuator. In such absence, the directives' acquisition (e.g., via voice, handwriting recognition, etc.) may be automatically triggered via the emulating associations of the relevance space, as configured. In the alternative, the directives and associated information acquisitions may be acquired unseparated, such as where both forms of information are voice information types, the voice recognition facilities are capable of distinguishing directives, and the voice recognition facilities understand to do so via the emulating association. Moreover, acquisition of directives may be omitted in certain cases, such as where the association is fixed for the information type. In each of these latter cases, it is preferred that the association remain uneffected subject to user response (or lack thereof within a time out period) to a directives' confirmation message, presented via the prompting facilities 240.

In providing support for shared relevance spaces and otherwise, the administration resources' configuration facilities 240 preferably enable user-specified configuration. That is, the configuration facilities 240 preferably enable users to add or delete one or more resources, operations and functions, including respecting the relevance space. As an example, a user of a PDA is enabled, upon the addition of a resource, to add the resource (or selected one or more of its operations/functions) to the shared relevance space. In a specific case, the user may configure the relevance space to accommodate an attachment, such as a digital camera or a modem. In the camera case, the user may provide that a snapshot (e.g., of a house for sale) is readily associated with exploiting resources that include one or more of photo manipulation (e.g., adding text respecting the price and location), calendaring (e.g., associating the photo to an appointment to tour the house), and e-mail (e.g., sending the photo to others for their input). In the modem case, the user may provide that existing emulating associations be effected using such connection—e.g., rather than staging the e-mail of the camera attachment case, the e-mail is sent directly via modem, provided that the modem is active.

In some implementations where configuration is subject to adjustment, the administration resources' configuration facilities 240 enable tracking of the use of resources, operation, and functions. Such tracking may be accomplished based on selected criteria, including, as examples, one or more of: the frequency of use; the information type(s) and exploiting resources implicated by the use(s); the implicated facilities of the processing, distribution and administration resources; other aspects of the directives; and, the day/date/time of the uses. Such tracking may be employed for various purposes, including, without exhaustion, to provide suggestions or feedback to the user in specifying a configuration and/or to provide for automatic updating of the configuration.

The acquisition, distribution and exploiting resources 202, 206, 208 preferably operate in coordination with the association resources 204. To illustrate, the association resources 204 provide directives to the distribution resources 206 so as to enable selected distribution of information from the acquisition resources 202 to the exploiting resources 208. In this manner and otherwise (such as through effecting the shared relevance space), the association resources 204 support enhanced coordination between the acquisition and exploiting resources 202, 208, whether such exploiting resources 208 are internal or external to the enabled information apparatus 200. In so doing, the association resources 204 contributes to reduced and/or minimized, and preferably optimally so, the amount of user skill and effort consumed toward any such distribution as to any particular information.

The association resources 204 preferably comprise a variety of facilities for selectively associating information. Such facilities typically include directive management facilities 244, annotating facilities 246 and association control facilities 248. The directive management facilities 244 support (a) receipt of the directives acquired by the acquisition resources 202 and (b) based on the directives' form, activate processing thereof via the processing resources 210 (e.g., recognition facilities). The directive management facilities 244 also support receipt of time-out messages from the administration resources 212, including so as to de-activate acquisition resources 202 in the event that directive information is not provided timely thereat. The directive management facilities 244 also support provision of the information—in annotated form—to the distribution resources 206.

The annotating facilities 246 support formulation of association annotations and the application of such annotations to implicated associated information. To illustrate, the facilities 246 preferably formulate the association annotations based on directives acquired by acquisition resources 202 so that such annotations, as distributed to exploiting resources 208 by the distribution resources 206, direct the resources 208 in effecting certain operations and functions respecting the associated information.

While the annotating facilities 246 formulate annotations based on acquired directives, the facilities 246 preferably are enabled to do so using all or only some (or even portions) of the directives, as befits the purpose of the directives. To illustrate in the case of a PDA, the user may voice directives comprising a string of operations and operands, some of which operations the facilities 246 exclude from, or transform in, the annotation for various reasons, including, as examples, the directives (or portions) (a) implicate processing and/or administration resources 210, 212 and/or (b) are understood, such as due to context, configurations, the remaining annotated directives, or other factors, alone or in combination. In an example case, acquired directives for certain associated information (“AI”) include: “send <AI> to <person> re <software app> for <append> to <data file> in form <data> confirm <by tone A>”. The association annotation may exclude (i) the operand “<AI>” of operator “send”, as the initial command of the directives is understood to apply to the acquired information, (ii) “re <software app>”, as that portion will be understood by the exploiting resources' information apparatus (e.g., in the Microsoft Windows operating systems, files are registered to specific application software, as indicated by the file's extension - for example, “.doc” is registered to and opened by Microsoft Word word processing program), (iii) “in form <data>”, as that portion is meant for processing resources 210 (e.g., to convert voiced information to data via recognition facilities), and (iv) “confirm <by tone A>”, as that portion is meant for administration resources 212 (e.g., to generate a confirmation prompt, in the form of a predetermined tone, upon distribution of the information and annotation to the exploiting resources).

The annotating facilities 246 preferably are enabled to formulate annotations based entirely, or in part, on configurations supported by the administration resources' configuration facilities 240. In particular, the facilities 246 may do so responsive to an applicable shared relevance space. To illustrate, the shared relevance space may direct that minimally-complex acquired directives be associated with relatively more complex annotations. In an example case, assume acquired directives for certain associated information (“AI”) include: “send <AI>”. In such case, the configuration facilities 240 may inform the annotating facilities 246 to formulate an annotation “send <AI> to <person> for <append> to <data file>”. Moreover, the configuration facilities 240 may inform the directive management facilities 244 of the directive “in form <data>” which, as previously described, is used to trigger the processing resources' recognition facilities.

The annotating facilities 246 preferably support various directives. In particular, the facilities 246 may do so responsive to an applicable shared relevance space. To illustrate, the facilities may support one or more of: global commands, which commands implicate, e.g., plural, or all, exploiting resources of a shared relevance space or otherwise; dedicated commands, which commands implicate one exploiting resource; and concatenating commands, which commands enable plural operands for a single operator (e.g., “send to <person1> <person2> [and] <person3>”).

The association control facilities 248 can be variously implemented. In any case, however, the facilities 248 provide for activating the association resources 204, including not only the operations/functions of the directive management facilities and annotating facilities, but also the acquisition of directives (e.g., via the acquisition resources' transducing facilities). Such activation generally is triggered through user manipulation or other actuation of the control facilities 248. As an example, in a PDA, acquisition of directives may be accomplished via a touch-sensitive screen, which screen is a typically supported transducing facility 220 and generally remains activated. In addition, however, in the PDA directives acquisition may be accomplished via one or more other transducers, each of which typically will have implicated association control facilities 248. Such PDA control facilities 248 typically include, as examples, a button (e.g., to activate a camera or microphone), a contact detector (e.g., to activate a hand-held optical scanner), or an audio signal strength detector (e.g., to activate an audio recorder).

In a typical embodiment, separate association control facilities 248 are provided for each transducing or coupling facilities 220,222. However, it is to be recognized that selected transducing and coupling facilities 220, 222 may be grouped together for activation through actuation of one association control facilities 248. In such case, the particular transducing and coupling facilities 200,222 that ultimately are activated may be variously determined: in one case, the most recently active of such facilities 220,222 is activated, while in another case, recently-added facilities may be activated and, in a third case, it is determined by context, typically in view of configurations (e.g., of a shared relevancy space). In any case, the prompting facilities 238 preferably are configured to send a confirmation prompt (e.g., timer components are triggered such that time-outs will occur if the user fails to respond within the time-out periods).

The association resources 204 and the acquisition resources 202 preferably are coordinated by control coordinating resources 214. The control coordinating resources 214 can be variously implemented; in any case, the resources 214 preferably are implemented so as to provide coordination that is smooth, natural, familiar, comfortable, easy or otherwise user friendly, and to provide transitions that preferably are transparent, or substantially transparent, between information and directive acquisition. In that regard, the control coordinating resources 214 preferably accommodate the application of directives other than from real-time, transducer-based acquisition. In such case, the directives may be stored, e.g., via the configuration facilities 240, including in connection with a shared relevance space. As such, the control coordinating resources 214 may be implemented not only to enable use of such directives, but also to ensure that directives are not otherwise acquired (e.g., by suspending operation of one or more acquisition and/or association control facilities 224, 248).

The coordinating resources 214 preferably also operate independently of the sequence of acquisitions. That is, the coordinating resources 214 typically accommodate either information or directives to be acquired first in time, as well as simultaneous and substantially simultaneous acquisitions. (Whichever actuation/directives is first actuated/acquired is understood to be “primary”. Whichever actuation/directives is next actuated/acquired understood to be “secondary”.)

The control coordinating resources 214 preferably also handle use both of common and of differing transducing facilities 220. To illustrate: in the former case, acquisition of both information and directives may be via a microphone; but, in the latter case, acquisition of information may be via a camera, while acquisition of directives is via a microphone.

In such former case, the coordinating resources 214 accommodate the acquiring of information and directives via common acquisition resources 202 and/or transducing facilities 220. Respecting that primary and secondary acquisitions generally do not proceed simultaneously, the coordinating resources 214 preferably are implemented to recognize the completion of the primary actuation/acquisition, so as to timely activate the other, secondary acquisition. That is, the control coordinating resources 214 typically are implemented so that, following primary actuation and acquisition, it supports activation—secondarily and automatically—of the acquisition resources 202 implicated by the other of such facilities 248, 224.

In such latter case wherein two different transducing facilities 220 are implicated, it is understood that the two acquisitions generally can proceed simultaneously, or at least substantially simultaneously. Accordingly, following a primary actuation (e.g., by the user) of one of the acquisition and association control facilities 224, 248, the control coordinating resources 214 typically are implemented so as to activate secondarily and automatically the acquisition resources 202 implicated by the other of such facilities 248, 224. While such secondary activation may be variously timed vis a vis the primary actuation, it is recognized that the secondary activation may be implemented to occur at such time as the user would likely be inclined to provide the implicated input (e.g., as indicated by some user action or otherwise).

In both cases, the coordinating resources 214 may be implemented to support directly the secondary activation of acquisition resources 202, e.g., through a bypassing of the control facilities 248, 224 of the secondarily activated resources 202. Even so, the coordinating resources 214 may be implemented to support secondary activation indirectly, including, as examples, (a) by actuation of such other secondary-implicated facilities 248, 224 and/or (b) based on pre-determined user manipulation of the primarily actuated control facilities 224, 248, e.g., the secondary activation being accomplished by the user's further manipulation(s) of the control facilities 224, 248 of the primary actuation. (An implementation relying on such further manipulation may, for instance, be implemented for acquisitions that implicate a shared relevance space.)

Such further manipulation(s), if employed, preferably are beyond those manipulations of the primary actuation. The further manipulations may be variously implemented; in any case, however, such manipulations typically are subject to, or are identified, via the timer facilities 236. Examples of further manipulations include (i) holding down (and/or releasing) a button for/following a time period beyond that which activates the primary acquisition, (ii) rocking a rocker switch from one position to the another position, (iii) depressing a button from a depressed position to a further depressed position, (iv) rolling a roller in one direction after having previously rolled the roller in the same or an opposite direction, and (v) otherwise engaging, re-engaging, further engaging or disengaging (in part or entirely) any actuator, physical or virtual or a combination of same.

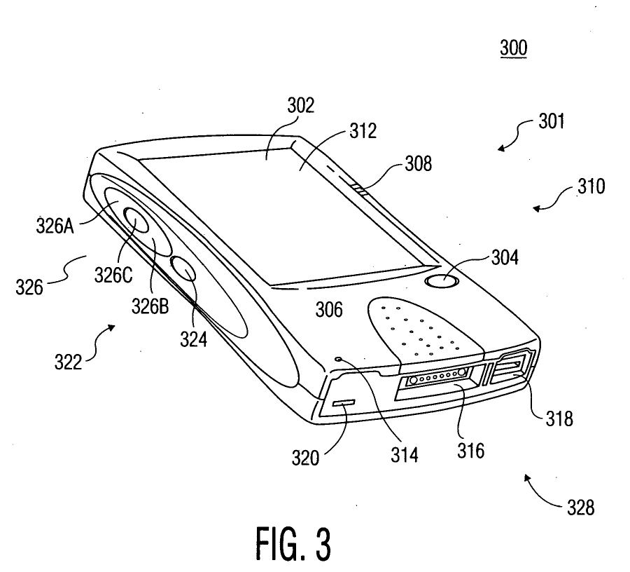

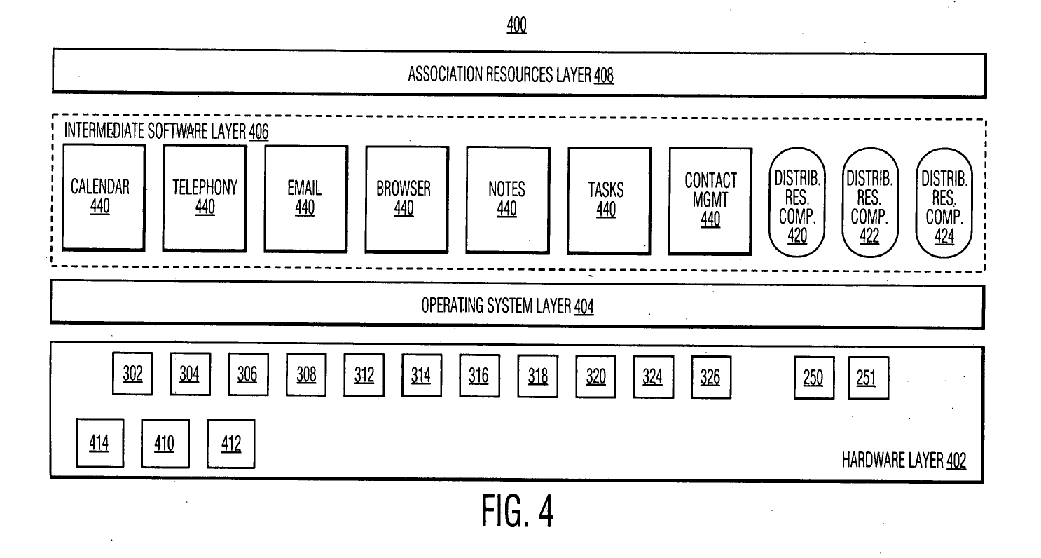

Turning to FIGS. 3 and 4, an enabled information apparatus is shown, implemented as a computing device—in the form of a PDA—in accordance with aspects of the invention. More specifically, FIG. 3 shows the PDA in an elevational view, while FIG. 4 shows the PDA in a block diagram.

In FIG. 3, the PDA 300 comprises: (a) exploiting resources 301, including a display screen 302, a display adjustment actuator 304 (e.g., for backlighting and/or contrast), a speaker 306 and indicator lights 308; (b) transducing/coupling facilities 310, including a touch-sensitive element 312 (associated with the display screen 302), a microphone 314, a docking connection 316, a communication port 318 and an IrDA port 320; (c) distribution resources 328, including the docking connection 316, the communication port 318 and the IrDA port 320; and (d) acquisition/association control facilities 322, including a customizable button 324 and a multifunction actuator 326 (note that the touch-sensitive element 312 may also be implemented as control facilities 322). The multifunction actuator has a first manipulation function 326A (e.g., to actuate information acquisition, such as via the microphone), a second manipulation function 326B (e.g, to actuate directives gathering, such as via the microphone, and a third manipulation position 326C (e.g., to trigger selected action). The first and second manipulation functions 326A/B, typically, behave like the two positions of a conventional rocker switch. The third manipulation function 326C typically behaves like a push button. Although not shown explicitly in all cases (or all facilities thereof, the PDA 300 is understood to comprise each of acquisition, association, distributing, exploiting, processing, administration and control coordination resources 202-214.

In FIG. 4, the PDA 400 is shown to comprise a hardware layer 402, an operating system (“OS”) layer 404, an intermediate software layer 406 and an association resources layer 408. The association resources layer 408 preferably comprises the software portions of the association and control coordination resources 204, 214. The layer association resources 408 is depicted as the uppermost layer to illustrate the central role of the resources thereof.

The hardware layer 402 comprises the elements described above respecting FIG. 3, as well as additional elements. The layer's additional elements include, as examples and without exhaustion: communication facilities 410; memory facilities 412; and processor facilities 414. The memory facilities 412 typically comprises one or more of cache memory, dynamic random access memory, mass storage, archival storage and any other hardware, firmware, software, or networking resources associated with storage.

The processor facilities 414, typically comprised at least in part by the processing resources 210, one or more processor(s) and/or other logic hardware. A processor can be any digital processing device including, without limitation, microprocessors, microcontrollers, digital signal processors or the like manufactured by Intel Corporation, Motorola Corporation, Texas Instruments, Inc., IBM, AMD, Cyrix, or any other manufacturer of digital processing devices. Other logic hardware includes custom and semi-custom circuitry including ASICs, PLDs, gate arrays or the like, either to operate alone or in combination with a processor.

The communication facilities 410, typically comprised at least in part by the distribution resources 206, include hardware associated with a communication stack. The communication stack may be implemented in whole or in part as a firmware element within the hardware layer 410 (in general purpose computing devices, however, it typically is software implemented as part of the OS layer 404). These facilities preferably are implemented so as to support any and all communication formats, protocols and specifications, whether presently used or not, as well as their equivalents and/or combinations thereof. Supported formats, protocols and specifications include, without limitation, the infrared standards (e.g., IrDA D and C, and AIR), the radio frequency standards (e.g., the proposed Bluetooth and Home RF specifications), and other connectivity standards (e.g., TCP/IP, the proposed HAVI and HAPI specifications, as well as USB, Firewire, and others).

The OS layer 404 can be variously implemented. As an example, it can comprise a commercial operating system, e.g., Windows CE, Linux or otherwise. Moreover, an OS preferably comprises a windowing or paneling system, for providing or supporting user interface functions and operations, including the display of prompts vis a vis the prompting facilities 238. At the same time, it is to be recognized that the OS can be absent, or can omit any windowing or paneling system, but instead provide or include a protocol or other basic resources to enable such systems. In this latter case, the enabled information apparatus 200 preferably comprises other resources for supporting an appropriate user interface. However provided, an appropriate user interface preferably is enabled. In that regard, the user interface preferably is a graphical user interface.

The OS layer 404 typically supports the overall operation of the apparatus. To illustrate, the OS layer 404 typically supports each of the acquisition, association, distribution, processing, control coordination, and exploiting resources via its provision and maintenance of device drivers, event handling, file management, memory management and other interfacing between the upper software layers 406, 408 and the hardware layer 402. In particular, it tends to support the administration resources 212, respecting each of the timer, prompting and configuration facilities 236-240. It also tends to support the distribution resources 206, respecting provision of a communication stack. The OS layer 404 also typically provides (e.g., part of file management) resource management facilities 430 for, e.g., the opening/closing of documents and launching/terminating of applications.

The intermediate software layer 406 can be variously comprised. In any case, such software layer 406 preferably provides functions that are relevant to the operation of the enabled information apparatus 200, but are otherwise not supported or not fully supported by the other layers 402, 404, 408. As an example, the intermediate software layer 406 can provide or enhance the operation of staging facilities 230, timer facilities 236, prompting facilities 238, configuration facilities 240, recognition facilities 252, encryption facilities 253, compression facilities 254, coding facilities 255 and composing facilities 256. To illustrate such provision, FIG. 4 sets out blocks for each of a distribution resources component 420, a processing resources component 422, and an administration resources component 424.

At the same time, the intermediate software layer 406 typically provides internal exploiting resources 208A. Such resources 208A generally take the form of bundled software applications 440. These applications 440, in a PDA, typically provide one or more of calendaring, telephony (e.g., dialing), e-mail (with and without attachments), browsing, note taking, task (“to do”) listing, contact management and scheduling.

It is to be recognized that the intermediate software layer 406 can be omitted. In such case, the operations and functions provided in the layer 406 can either not be supported or can be provided by one or more other layers. For example, the layer's configuration facilities 240 of the administration resources component 424 could be implemented as part of the association resources layer 408, particularly as to a shared relevance space.

The PDA of FIGS. 3 and 4, through its configuration facilities 240 (whether supported in the intermediate software layer 406 or otherwise), preferably supports a shared relevance space defined around transportability. The PDA's shared relevance space is implemented for (a). audio information (e.g., voice) acquired via the microphone 314, in connection with (b) the bundled software applications 440 and the resource management facilities 430. That is, the PDA enables configured associations between the audio information type (and/or the microphone 314) and identified operations/functions of such applications 440 and facilities 430. Preferably, the PDA's overall number of so-configured associations remains manageably small, as indicated by a manageably small number of recognized directives, examples of which include: “go to <X>” to launch an application “X”; “open <X>” to open a note (or file) “X”; “calendar <X>” to launch the calendar application, presented according to view X (e.g., a particular day); “dial <X>” to launch the telephony application and activate the dialer feature so as to sound, through the speaker 306, DTMF tones of a stated number “X” or a number, or selected number, for a stated person or entity “X”; “read <X>” to read, by voice synthesis, a note, or a file or an entry in a calendar, or other configured information, as denoted by “X”; “show details <X>” to display details about a person “X”of the contact management application; “e-mail <X>” to launch the e-mail application, address an email form to “X” and to include a transcribed-to-text voice message or to attach (via an additional command) other notes or files; and “voicemail <X>” to launch the email application, address an email form to “X” and to append an acquired voice memo.

Moreover, the PDA typically is implemented so as to consume minimal user interaction in order to acquire audio files and to direct such files. As such, the above commands typically are accompanied by additional commands. These commands typically include additional details or subcommands (e.g., navigation) applicable to the exploiting resource, and/or particulars applicable to any of the processing, administration or distribution resources.

As the PDA's relevance space implicates the microphone 314 for both information and directives, this transducing facility 220 is controlled by user manipulation of an actuator. The applicable actuator can be either the customizable button 324 or the multifunction actuator 326. In the button's case, depression (i.e., primarily manipulation) activates acquisition of associated information and further depression (i.e., secondary manipulation) such as by any one of further depression, holding or release, activates acquisition of directives. As previously described these acquisitions can come in either order. Moreover, in some cases, directives may be absent any associated information (e.g., the information subject to the directives is already present, as in opening a note or an application). In the multifunction actuators case, the primary and secondary manipulations correspond to selected manipulation functions 3256A-C, as described above.

The PDA's relevance space implicates the microphone 314 for training. The training method relies on teaching the PDA to recognize (e.g., the recognition facilities 252) the voice of the user, both for commands and the operands thereof. For example, in using the “voicemail”, the associated information is sent (in a wav format or as phonemes) as an attachment to an email; however, the email itself typically is addressed by the PDA's recognizing the user's articulation of a name listed via the calendar application and, perhaps, the location of the email address (e.g., “home”).

Through training, the PDA preferably enables additional directives to be added to the relevance space. The PDA preferably also enables deletions or modifications to existing directives.

The foregoing description and embodiments are not limitations, but examples. It is to be recognized that many modifications and variations are possible in the details, materials, and arrangements of the elements, operations and functions that are described and illustrated. Any such modifications and variations do not depart from the spirit and scope of the teachings and claims contained herein.

1-20. (canceled)

21. A method of initiating a phone call, comprising:
providing a mobile telephone having a display, a memory for storing phone numbers, a processor for providing speech recognition capability, a microphone, a dialer means, and a speaker;
displaying at least one textual representation, the representation being associated with a phone number stored in the memory;
receiving a voice command communicated via the microphone;
processing the voice command to select a phone number to be dialed;
communicating an audio representation of the phone number through the speaker; and
initiating a telephone call.

22. A method as set forth in claim 21, wherein the step of displaying a textual representation includes displaying a name.

23. A method as set forth in claim 22, wherein the step of communicating the audio representation includes speaking the name.

24. A method as set forth in claim 21, wherein the step of receiving a voice command includes receiving a name.

25. A method as set forth in claim 21, wherein the step of receiving a voice command includes receiving a phoneme.

26. A method as set forth in claim 21, wherein the step of receiving a voice command includes receiving a number.

27. A method as set forth in claim 21, wherein the step of receiving a voice command includes receiving a telephone number.

28. A method as set forth in claim 21, wherein the step of initiating a telephone call includes running a telephony application program.

29. A hand-held information apparatus for initiating telephone calls, comprising:
an information acquisition resource including a microphone for receiving voice commands and audio data;
an administration resource including a memory coupled with the information acquisition resource for storing the audio data;
a processing resource coupled to the information acquisition resource for running a voice recognition application that process the voice commands; and
a distribution resource coupled to the processing resource for dialing telephone calls in response to the voice commands.

30. A hand-held information apparatus as set forth in claim 29, wherein the administration resource stores phone numbers corresponding with the audio data to enable the processing resource to utilize voice recognition application to compare the stored audio data with the voice commands to dial telephone calls.

31. A hand-held information apparatus as set forth in claim 30 further comprising a touch-sensitive screen for listing the telephone numbers, or textual representations thereof, the touch-sensitive screen being coupled with the processing resource to enable selection of the listed telephone numbers to dial a telephone call as an alternative to utilization of the voice recognition application.

32. A hand-held information apparatus as set forth in claim 30 further comprising a means for activating the information acquisition resource.

33. A hand-held information apparatus as set forth in claim 32 further comprising prompting facilities having a timer component, the voice recognition application includes a confirmation prompt, whereby the timer component triggers a time-out should a user fail to respond to the confirmation prompt.

34. A hand-held information apparatus as set forth in claim 33, wherein the information acquisition resource acquires speech and the voice recognition application translates the acquired speech to text, which is stored in the memory.

35. A hand-held information apparatus as set forth in claim 30, wherein the voice recognition application translates the text into synthesized speech and the hand-held information apparatus includes a speaker for communicating the synthesized speech to a user.
